(19) United States
(12) Patent Application Publication
(10) Pub. No.: US 2006/0078168 A1
(43) Pub. Date: Apr. 13, 2006

(54) Equipment for inspecting quality of printed matter

(75) Inventor: Ryosuke Takahara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Webtech Co., LTD., Tokyo (JP)

(21) Appl. No.: 10/531,453

(22) PCT Filed: Sep. 24, 2003
(86) PCT No.: PCT/JP03/12138

§ 371 Date: Apr. 14, 2005

(30) Foreign Application Priority Data
Oct. 18, 2002 (JP) 2002-304397

(51) Int. Cl. G06K 9/00

(52) U.S. Cl. 382/112

(57) ABSTRACT

Printed matter (1) printed by a sheet-fed printer is illuminated on an impression cylinder (2) by illuminating means (13) and is pressed by air injection means (15) against the impression cylinder (2). When the light reflected on the printed matter (1) is detected by the photographing means (14) to import image information of the printed matter (1), the photographing means (14) has a photo position (P) on the printed matter (1) linearly along an axis of the impression cylinder (2); the illuminating means (13) condenses the illumination light into line along the axis of the impression cylinder (2) and in conformity with the photo position (P) on the printed matter (1), the air injection means (15) stably pressing the printed matter (1) at the photo position (P) on the printed matter against the impression cylinder (2) so as to photograph a whole surface of the printed matter (1) from photo-start to photo-end positions.

### TECHNICAL FIELD

The present invention relates to a system for inspecting quality of printed matter which detects any defects of the printed matter such as stains and color shadings.

### BACKGROUND ART

In general, printed matter printed, for example, by a sheet-fed printer may have defects such as stains and color shadings. Thus, it has been conceived to provide a system which inspects printed matter on an impression cylinder in line just after printing.

The inspection system comprises, as shown in FIG. 1, illuminating means or fluorescent lamps 3 arranged to illuminate printed matter 1 on an impression cylinder 2, photographing means or a camera 4 surrounded by the fluorescent lamps 3 and detecting light illuminated by the lamps 3 and reflected on the printed matter 1 so as to import image information of the printed matter 1 and an image processing unit 5 processing the image information inputted by the camera 4.

The image processing unit 5 comprises an A/D converter 6 digitizing an image signal of the image information imported by the camera 4, a reference memory 7 storing a reference signal when the printed matter 1 is normal and a CPU 8 comparing the digitized image signal from the A/D converter 6 with the reference signal from the reference memory 7, the CPU 8 being connected to a pulse generator 9 detecting rotational frequency of the cylinder 2, display means 10 displaying information such as comparative results and input means 11 inputting information such as starting of inspection.

When the printed matter 1 is to be inspected by the inspection system, the printed matter 1 moved together with rotation of the impression cylinder 2 is photographed by the camera 4 to import the image information of the printed matter 1. An image signal of the imported image information is fed through the A/D converter 6 to the CPU 8 where the image signal of the image information is compared with the reference signal of the reference memory 7 to detect any defects of the printed matter 1. Importation of the image signal by the camera 4 is controlled via the CUP 8 by the pulse generator 9 so as to synchronize the movement of the printed matter 1 with the rotation of the moving impression cylinder 2.

The printed matter 1 moved together with the rotation of the impression cylinder 2 is locked at its leading edge by a gripper 12 and is clamped at its trailing edge by the impression cylinder 2 and a blanket cylinder 2a so that the printed matter 1 is closely contacted on a peripheral surface of the impression cylinder 2.

However, upon release of the printed matter 1 from the cylinders 2 and 2a, the trailing end of the printed matter 1 becomes entirely free while the leading edge is fixed by the gripper or the like. As a result, a trailing portion of the printed matter 1 (a portion of the printed matter 1 in FIG. 1 shown by imaginary lines) flaps into unstable position relationship of the printed matter 1 with the camera 4, disadvantageously resulting in failure of accurate inspection of the printed matter 1.

In order to overcome this problem, it has been proposed to arrange air injection means (not shown) outside of the lamps 3 to blow air from above against the impression cylinder 2, thereby closely contacting the printed matter 1 with thickness of the order of 0.01 mm on the impression cylinder 2; alternatively, as disclosed in JP 62-25047A, a bail mechanism (not shown) is separately arranged to contact the printed matter 1 on the impression cylinder 2 directly by means of holding rollers or the like. In this respect, the state of the art on systems for inspecting quality of printed matter is disclosed, for example, in JP 10-166557A.

However, the air injection means outside of the fluorescent lamps 3 to press the printed matter 1 against the impression cylinder 2 through air cannot surely press the printed matter 1 against the impression cylinder 2 when the printed matter 1 is thick to some extent (thickness of more than 0.3 mm) or is metal sheet such as tin sheet, failing to inspect a whole surface of the printed matter 1. Direct holding of the printed matter 1 by the bail mechanism is accompanied by complexity of the structure, leading to increase in cost; it may not be usable depending upon a print design of the printed matter 1 since the printed matter 1 requires margins for contact with the holding rollers or the like. Moreover, the fluorescent lamps 3 occupy considerable space to interfere with peripheral devices and have not sufficient illumination intensity required for the importation of image information by the camera 4.

The present invention was made in view of the above and has its object to provide a system for inspecting quality of printed matter which surely presses the printed matter against an impression cylinder with no limitation to a print design of the printed matter and which affords illumination intensity enough for importation of image information by photographing means.

### SUMMARY OF THE INVENTION

The invention is directed to a system for inspecting quality of printed matter comprising illuminating means for illuminating the printed matter, printed by a sheet-fed printer, on an impression cylinder, photographing means for detecting light illuminated by said illuminating means and reflected on the printed matter to import image information of the printed matter and air injection means for pressing said printed matter against the impression cylinder, thereby inspecting any defects of the printed matter in line on the basis of said image information, wherein

said photographing means has a photo position on the printed matter linearly along an axis of the impression cylinder,

said illuminating means being adapted to condense illumination light into line along the axis of the impression cylinder, thereby making the same in conformity with the photo position on the printed matter,

said air injection means being adapted to stably press the printed matter at the photo position so as to photograph a whole surface of the printed matter from photo-start to photo-end positions.

Thus, the photo position of the photographing means on the printed matter is in conformity with the illumination light from the illuminating means, the air injection means being arranged to safely press the printed matter at the photo position against the impression cylinder, whereby the printed matter is surely pressed against the impression cylinder; as a result, quality inspection of the printed matter can be effected with high accuracy. Since the air injection means blows the air to press the printed matter, margins for contact becomes unnecessary and the printed matter can be pressed against with no limitation to print design. Moreover, the illuminating means condenses the light for conformity with the photo position on the printed matter, so that the illuminating means can be made compact in size to prevent interference with peripheral devices and enough illumination intensity can be ensured for importation of the image information by the photographing means.

The air injection means of the invention may have an air pressing position, at which the printed matter is pressed against the impression cylinder, adjacent to the photo position on the printed matter and air may be blown substantially perpendicular to the printed matter. These make the printed matter further surely pressed at the photo position against the impression cylinder, so that quality inspection of the printed matter can be effected with higher accuracy. Blowing of air substantially perpendicular to the printed matter can reduce any turbulences on the printed matter, which suppresses the printed matter from flapping.

The air injection means of the invention may have the air pressing position, at which the printed matter is pressed against the impression cylinder, in conformity with the photo position on the printed matter. This makes the printed matter strongly pressed at the photo position against the impression cylinder, so that quality inspection of the printed matter can be effected with further higher accuracy.

The air injection means of the invention may have a distance from the air injection ports to a surface of the printed matter in a range of 5-30 mm and may have air static pressure at the air injection ports, by which the printed matter is pressed against the impression cylinder, in a range of 5-30 kPa. These make the printed matter suitably and strongly pressed at the photo position against the impression cylinder, so that quality inspection of the printed matter can be effected with still further higher accuracy.

The illuminating means of the invention may comprise an ellipsoidal reflector or a cylindrical lens condensing the illumination light into line along an axis of the impression cylinder. Thus, the illumination light can be condensed into line in conformity with the photo position on the printed matter, which makes it possible to make the illuminating means further compact in size to prevent interference with peripheral devices and to enhance the illumination intensity for importation of image information by the photographing means. The illuminating means of the invention may have the illumination light to the printed matter tilted by 5°-50° to the photo line from the photographing means to the printed matter. This can prevent the illuminating means from interfering with peripheral devices and make the illumination intensity suitable for importation of image information by the photographing means.

### BRIEF DESCRIPTION OF DRAWINGS

FIG. 1 is a schematic view showing a conventional system for inspecting quality of printed matter;

FIG. 2 is a schematic view showing a system for inspecting quality of printed matter according to a first embodiment of the invention;

FIG. 3 is a view looking in the direction of arrows II in FIG. 2;

FIG. 4 is a schematic view showing a structure of illuminating means used in the system for inspecting quality of printed matter according to the first embodiment of the invention;

FIG. 5 is a schematic view showing a system for inspecting quality of printed matter according to a second embodiment of the invention; and

FIG. 6 is a schematic view showing a structure of illuminating means used in the system for inspecting quality of printed matter according to the second embodiment of the invention.

### BEST MODE FOR CARRYING OUT THE INVENTION

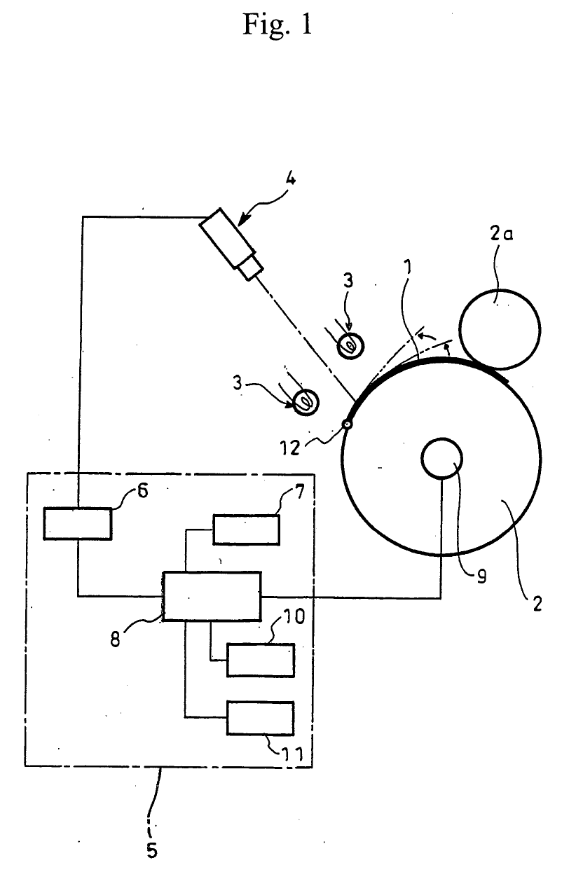

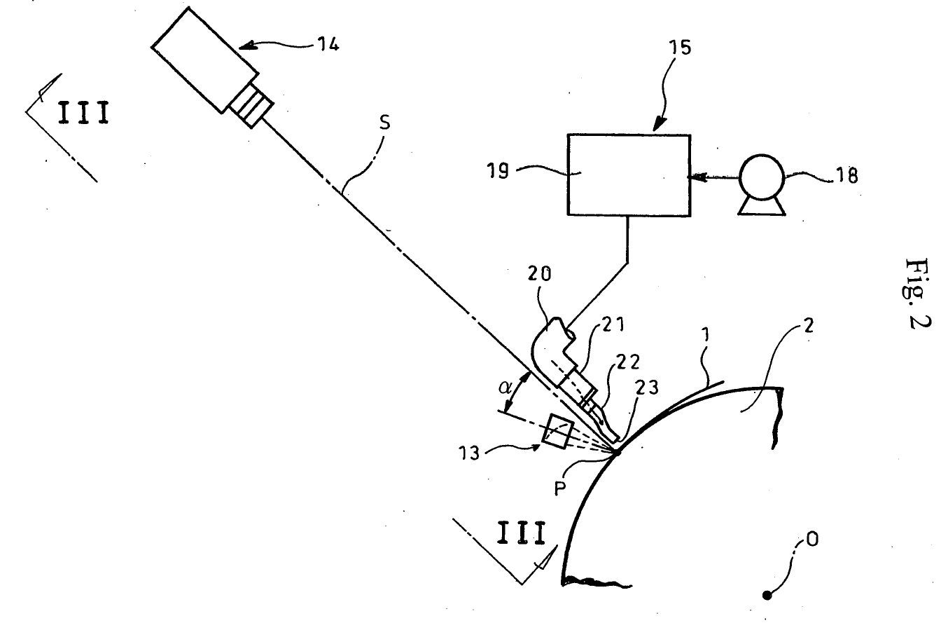

FIGS. 2-4 show a system for inspecting quality of printed matter according to a first embodiment of the invention in which parts similar to those in FIG. 1 are designated by the same reference numerals.

The system for inspecting quality of printed matter according to the first embodiment comprises illuminating means 13 adapted to illuminate printed matter 1 on an impression cylinder 2, photographing means 14 for detecting light illuminated by the illuminating means 13 and reflected on the printed matter 1 to import image information of the printed matter 1, air injection means 15 for pressing the printed matter 1 against the impression cylinder 2 and an image processing unit (not shown) for processing the image information inputted by the photographing means 14.

The photographing means 14 is a wide-angle CCD camera spaced apart by a predetermined distance from the impression cylinder 2 and oriented to an axis 0 of the cylinder 2. A photo position P on the printed matter 1 by the CCD camera is linear along an axis of the impression cylinder 2 and has a predetermined range of length L so as to correspond to a maximum width of the printed matter on the impression cylinder 2. The photographing means 14 may be an analog camera which processes information of photographed image in analog representation; alternatively, it may be a digital camera which internally digitizes information of the photographed image.

The illuminating means 13 comprises a light source or white LED (light emitting diode) 16 and an ellipsoidal reflecting mirror 17 extending axially of the impression cylinder 2 and having a predetermined curved surface, light illuminated by the white LED 16 being condensed by the reflecting mirror 17 into line along the axis of the impression cylinder 2 and being substantially in conformity with the photo position P of the photographing means 14 on the printer matter 1. The reflecting mirror 17 tilts the illumination light to be directed to the printed matter 1 by a range of 5°-50° (inclined angle α) preferably in a range of 15°-45° and further preferably in a range of 20°-30° with respect to photo line S from the photographing means 14 to the printed matter 1 and is arranged so as not to be an obstacle to a photo area of the photographing means 14; the illumination intensity of the reflected illumination light is set to more than 5.0×10³ lx, preferably more than 1.0×10⁴ lx. This illumination intensity is equal to that of two fluorescent lamps at a distance of 20 mm to the printed matter 1.

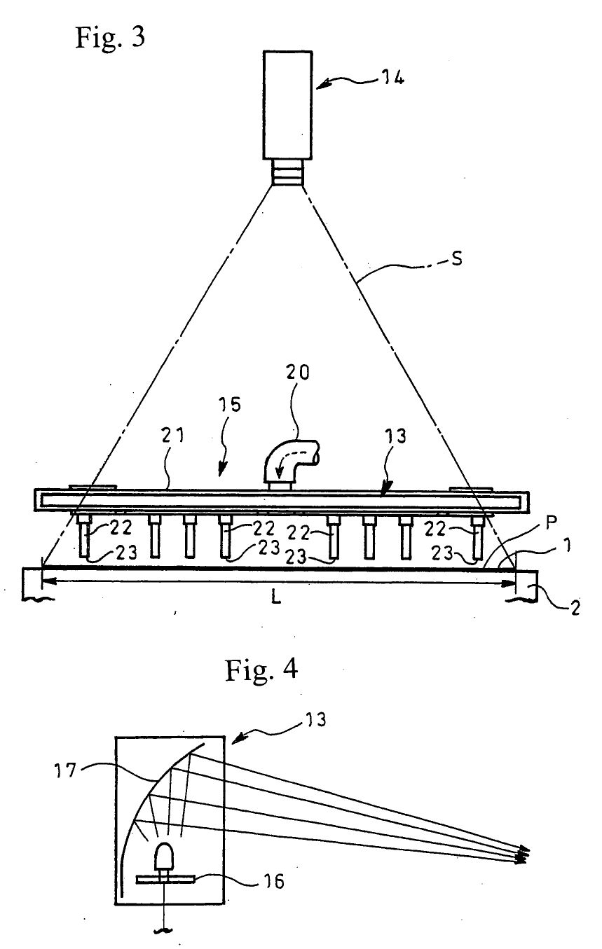

The air injection means 15 comprises an air blower 18, an air injection body 19 controllably feeding the air from the air blower 18, an air injection seat 21 connected via a pipe 20 to the air injection body 19 and extending axially of the impression cylinder 2 and a plurality of (eight in FIG. 3) air nozzles 22 injecting air from the seat 21 to the printed matter 1, each of these members being arranged so as not to be an obstacle to the photo area of the photographing means 14 and to an illumination range of the illuminating means 13. Tip ends of the air nozzles 22 extend along the photo line S from the photographing means 14 to the printed matter 1 (line of orientation from the CCD camera to the axis 0 of the impression cylinder 2) and are directed substantially perpendicular to the printed matter 1. The tip ends of the air nozzles 22 come closer to the photo line S by several millimeters and come closer to the photo position P on the printed matter 1 such that they extend to have a distance from the air injection ports 23 to the surface of the printed matter 1 in a range of 5-30 mm, preferably in a range of 10-15 mm; air static pressure of the air injection ports 23 is set to be in a range of 5-30 kPa, preferably in a range of 10-25 kPa; and wind velocity is set to be in a range of 5-120 m/sec.

The image processing unit (not shown) is substantially similar to conventional ones and comprises an A/D converter (not shown) digitizing an image signal of image information imported by the photographing means 14, a reference memory (not shown) storing a reference signal when the printed matter 1 is normal and a CPU (not shown) comparing the digitized image signal from the A/D converter with the reference signal from the reference memory, the CPU being connected to a pulse generator (not shown) detecting rotational frequency of the impression cylinder 2, the illuminating means 13 and the air injection means 15 so that each of them may be controlled. If the photographing means 14 is a digital camera which can internally digitize information of the photographed image, no A/D converter in the image processing unit is required.

When the printed matter 1 is to be inspected by the inspection system, air is blown via the ports 23 of the nozzles 22 to press the printed matter 1, a tip end of which is locked by the gripper (not shown), at the position (air pressing position on the printed matter 1) adjacent to the photo position on the printed matter 1 against the impression cylinder 2 while, at the same time, the photographing means 14 detects the light illuminated by the illuminating means 13 and reflected on the printed matter 1 to import image information of the printed matter 1. The air injection means 15 always presses the printed matter 1 at the position (air pressing position of the printed matter 1) adjacent to the photo position P on the printed matter 1 through air such that the photographing means 14 can photograph a whole surface of the printed matter 1 from photo-start to photo-end positions.

As is conventionally done, the image signal of the image information imported by the photographing means 14 is fed via the A/D converter to the CPU where the image signal of the image information is compared with the reference signal of the reference memory so as to detect any defects of the printed matter 1.

Thus, according to the first embodiment, the photo position P of the photographing means on the printed matter is in conformity with the light illuminated by the illuminating means 13, the air injection means 15 being arranged so as to stably press the printed matter 1 at the photo position P against the impression cylinder 2, so that the printed matter 1 can be surely pressed against the impression cylinder 2 even if the printed matter is thick to same extent (thickness of more than 0.3 mm) or is metal sheet (with thickness of less than 0.3 mm); as a result, quality inspection of the printed matter 1 can be effected with high accuracy. Since the air injection means 15 blows air to press the printed matter 1, no margins on the printed matter 1 are required for touching on the printed matter 1, so that printed matter 1 can be pressed against with no limitations on print design. Moreover, the illuminating means 13 condenses the light for conformity with the photo position P on the printed matter, so that the illuminating means 13 can be made compact in size so as to prevent interference with peripheral devices while illumination intensity for importation of the image information by the photographing means 14 can be sufficiently ensured.

When the air injection means 15 has the air pressing position on the printed matter 1, at which the printed matter 1 is pressed against the impression cylinder 2, adjacent to the photo position P on the printed matter 1 and the air is blown substantially perpendicular to the printed matter 1, the printed matter 1 is further surely pressed at the photo position P against the impression cylinder 2, so that quality inspection of the printed matter 1 can be effected with higher accuracy. Blowing of air substantially perpendicular to the printed matter 1 can reduce any turbulences on the printed matter, which suppresses the printed matter 1 from flapping.

When the air injection means 15 has a distance from the air injection ports 23 to the surface of the printed matter 1 in a range of 5-30 mm, preferably in a range of 10-15 mm, and the air static pressure at the air injection ports 23, by which the printed matter 1 is pressed against the impression cylinder 2, is set to a range of 5-30 kPa, preferably in a range of 10-25 kPa, the printed matter 1 can be suitably and strongly pressed at the photo position P against the impression cylinder 2, so that quality inspection of the printed matter 1 can be effected with still further higher accuracy. If the distance from the air injection ports 23 to the surface of the printed matter 1 were less than 5 mm or the air static pressure at the air injection ports 23 were more than 30 kPa, then turbulences on the printed matter 1 would increase, failing to suppress the printed matter 1 from flapping. If the distance from the air injection ports 23 to the surface of the printed matter 1 were more than 30 mm or the air static pressure at the air injection ports 23 were less than 5 kPa, then the printed matter 1 could not be sufficiently pressed at the photo position P against the impression cylinder 2. By contrast, if the distance from the air injection ports 23 to the surface of the printed matter 1 is set to be in a range of 10-15 mm or the air static pressure at the air injection ports 23 is set to be in a range of 10-25 kPa, then the printed matter 1 can be most suitably and most strongly pressed at the photo position P against the impression cylinder 2.

When the illuminating means 13 comprises the ellipsoidal reflector 17 condensing the illumination light into line along the axis of the impression cylinder 2, the illumination light can be condensed into line in conformity with the photo position on the printed matter 1, so that the illuminating means 13 can be made further compact in size to prevent interference with peripheral devices and to enhance the illumination intensity for importation of image information by the photographing means 14. When the illumination intensity of the illumination light from the illuminating means is set to more than 5.0×10³ lx, the photographing means 14 can suitably import the image information; if more than 1.0×10⁴ lx, photographing means 14 can most suitably import the image information.

When the illuminating means 13 has the illumination light to the printed matter tilted by 5°-50° (inclined angle α) to the photo line S from the photographing means 14 to the printed matter 1, the illuminating means 13 can be prevented from interfering with the peripheral devices and the illumination intensity can be made suitable for importation of image information by the photographing means 14. If the inclined angle α were less than 50, the arrangement of the illuminating means 13 might interfere with the peripheral devices and/or with the photo range of the printed matter 1; if the inclined angle α were more than 50°, the light reflected on the printed matter 1 would have the illumination intensity too weak to enough importation of the image information by the photographing means 14. By contrast, when the inclined angle α is in a range of 15°-45°, the prevention of interfere with the peripheral devices and the like can be suitably balanced with illumination intensity of the reflected light; when the inclined angle α is in the range of 20°-30°, the prevention of interfere with the peripheral devices and the like can be most suitably balanced with illumination intensity of the reflected light.

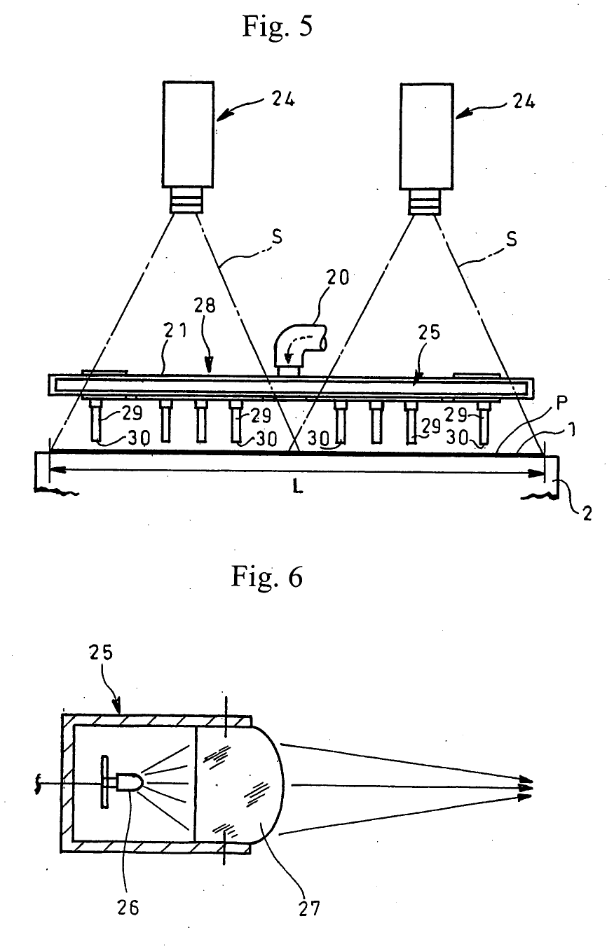

FIGS. 5 and 6 show a second embodiment of the invention wherein parts similar to those in FIGS. 2-4 are designated by the same reference numerals.

The quality inspection system according to the second embodiment is substantially similar to that of the first embodiment except for the number of the photographing means 14, the kind of the illuminating means 13 and the direction of the air nozzles of the air injection means 15; alternatively, it may be constituted by not all of the above-mentioned changes but by one or some of them.

The photographing means 24 comprises two wide-angle CCD cameras arranged in combination; each of them is spaced apart by a predetermined distance from the impression cylinder 2 and is orientated to the axis of the impression cylinder 2, the photo position P on the printed matter 1 by the two CCD cameras is linear along the axis of the impression cylinder 2 and has a predetermined range of length L so as to correspond to a maximum width of the printed matter on the impression cylinder 2.

The illuminating means 25 comprises a light source or white LED (light emitting diode) 26 and a cylindrical lens 27 adapted for convergence of light into a single direction, the light illuminated by the white LED 26 being condensed by the cylindrical lens 27 into line along the axis of the impression cylinder 2 and substantially in conformity with the photo position P of the photographing means 24 on the printed matter 1. As in the case of the ellipsoidal reflector 17 in the first embodiment, the cylindrical lens 27 tilts the illumination light to be directed to the printed matter 1 by a range of 5°-50° (inclined angle α), preferably in a range of 20°-30° with respect to the photo line S from the photographing means 24 to the printed matter 1 (line of orientation from the CCD camera to the axis of the impression cylinder 2) and is arranged so as not to be an obstacle to the photo area of the photographing means 24; the illumination intensity of the reflected illumination light is set to be more than 5.0×10³ lx, preferably more than 1.0×10⁴ lx.

As in the case of the first embodiment, an air injection means 28 comprises an air blower (not shown), an air injection body (not shown) controlling air from the air blower (not shown) for supplying, an air injection seat 21 connected via a pipe 20 to the air injection body (not shown) and extending axially of the impression cylinder 2 and a plurality of (eight in FIG. 5) air nozzles 29 injecting air from the seats 21 to the printed matter 1, each of these components being arranged so as not to be an obstacle to the photo area of the photographing means 24. The tip ends of the air nozzles 22 extend along the photo line S from the photographing means 24 to the printed matter 1 (line of orientation from the CCD camera to the axis of the impression cylinder 2), the air injection ports 30 being directed to the photo position P on the printed matter 1. The tip ends of the air nozzles 22 have the distance range and the air static pressure range substantially similar to those of the first embodiment.

When the printed matter 1 is to be inspected by the printed matter inspection system, air is blown from the injection ports 30 of the nozzles 22 to press the printed matter 1 whose tip end is anchored by the gripper (not shown) against the impression cylinder 2 at the photo position P on the printed matter 1 (air pressing position on the printed matter 1) while the photographing means 24 detects the light illuminated by the illuminating means 25 and reflected on the printed matter 1 to import the image information of the printed matter 1. The air injection means 28 always presses the printed matter 1 at the photo position P on the printed matter 1 (air pressing position on the printed matter 1) such that the photographing means 24 can photograph a whole surface of the printed matter 1 from photo-start to photo-end positions.

As is conventionally done, the image signal of the image information imported by the photographing means 24 is processed so as to detect any defects of the printed matter 1.

Thus, the second embodiment can have effects and advantages similar to those in the first embodiment. Because of the photographing means 24 comprising two CCD cameras, quality inspection of the printed matter 1 can be carried out with more accuracy.

When the air injection means 28 has the air pressing position, at which the printed matter 1 is pressed against the impression cylinder 2, in conformity with the photo position P on the printed matter 1, the printed matter 1 is strongly pressed at the photo position P against the impression cylinder 2, so that quality inspection of the printed matter 1 can be effected further with higher accuracy.

When the illuminating means 25 comprises the cylindrical lens 27 condensing the illumination light into line along the axis of the impression cylinder 2, the illumination light can be condensed for conformity with the photo position P on the printed matter 1, so that the illuminating means 25 can be further made compact in size to prevent interfere with the peripheral devices and to enhance illumination intensity for importation of the image information by the photographing means 24.

It is to be understood that a system for inspecting quality of printed matter according to the invention is not limited to the above embodiments and that various changes and modifications may be effected without leaving the gist of the invention. For example, kind and number of the photographing means may be any; the light source of the illuminating means may be any provided that a predetermined illumination intensity is provided; the air injection means may have any structure provided that air can be injected under the conditions shown in the first embodiment.

### INDUSTRIAL APPLICABILITY

As is clear from the above, a system for inspecting quality of printed matter according to the present invention is suitable for surely pressing a printed matter against an impression cylinder and for effecting quality inspection of the printed matter when the printed matter is to be inspected in line. It is also suitable for making unnecessary any margins for contact with the printed matter and for pressing the printed matter with no limitation to print design. It is further suitable for making the illuminating means compact in size to prevent interfere with peripheral devices and for making the illumination intensity acquired enough for importation of the image information by the photographing means.

1. A system for inspecting quality of printed matter comprising illuminating means for illuminating the printed matter, printed by a sheet-fed printer, on an impression cylinder, photographing means for detecting light illuminated by said illuminating means and reflected on the printed matter to import image information of the printed matter and air injection means for pressing said printed matter against the impression cylinder, thereby inspecting any defects of the printed matter in line on the basis of said image information, characterized in that
said photographing means has photo position on the printed matter linearly along an axis of the impression cylinder,
said illuminating means being adapted to condense illumination light into line along the axis of the impression cylinder, thereby making the same in conformity with the photo position on the printed matter,
said air injection means being adapted to stably press the printed matter at the photo position so as to photograph a whole surface of the printed matter from photo-start to photo-end positions.

2. The system for inspecting quality of the printed matter as claimed in claim 1 wherein the air injection means has an air pressing position on the printed matter at which the printed matter is pressed against the impression cylinder and which comes closer to the photo position on the printed matter, air being blown substantially perpendicular to the printed matter.

3. The system for inspecting quality of the printed matter as claimed in claim 1 wherein the air injection means has an air pressing position at which the printed matter is pressed against the impression cylinder and which is in conformity with the photo position on the printed matter.

4. The system for inspecting quality of the printed matter as claimed in any of claims 1-3 wherein the air injection means has a distance from air injection ports to a surface of the printed matter in a range of 5-30 mm, air static pressure of the air injection ports by which the printed matter is pressed against the impression cylinder being set to a range of 5-30 kPa.

5. The system for inspecting quality of the printed matter as claimed in claim 4 wherein the illuminating means comprises an ellipsoidal reflector for condensing illumination light into line along an axis of the impression cylinder.

6. The system for inspecting quality of the printed matter as claimed in claim 4 wherein the illuminating means comprises a cylindrical lens for condensing illumination light into line along an axis of the impression cylinder.

7. The system for inspecting quality of the printed matter as claimed in claim 5 or 6 wherein the illuminating means tilts the illumination light directed to the printed matter in a range of 5°-50° to photo line from the photographing means to the printed matter.
